(19) United States
(12) Patent Application Publication
(10) Pub. No.: US 2025/0024383 A1
(43) Pub. Date: Jan. 16, 2025

(54) FREQUENCY BAND POWER LIMIT REPORTING IN A USER EQUIPMENT

(71) Applicant: QUALCOMM Incorporated, San Diego, CA (US)

(72) Inventors: Chan-Jui Chian, Taipei City (TW); Chia-Wei Chang, Taipei City (TW); Tzui Lu, Taipei City (TW); Tsung-Te Hou, New Taipei City (TW); Kai-Chun Huang, Taipei City (TW); Wei-Che Chang, New Taipei City (TW); Yuwei Pan, New Taipei City (TW); Cheng-Ting Tsai, Taipei City (TW)

(21) Appl. No.: 18/350,520

(22) Filed: Jul. 11, 2023

(51) Int. Cl. H04W 52/36; H04W 36/08

(52) U.S. Cl. CPC H04W 52/367; H04W 36/08

(57) ABSTRACT

This disclosure provides systems, methods, and devices for wireless communication that support transmission of power limit indications for a UE associated with different frequency bands. In a first aspect, a method of wireless communication includes detecting a first trigger condition for transmission of at least a first indication of a first transmission power limit of the UE and a second indication of a second transmission power limit of the UE, wherein the first transmission power limit is associated with a first frequency band supported by the UE and the second transmission power limit is associated with a second frequency band supported by the UE and transmitting, to a first network node associated with the first frequency band, the first indication and the second indication in accordance with detection of the first trigger condition. Other aspects and features are also claimed and described.

### TECHNICAL FIELD

Aspects of the present disclosure relate generally to wireless communication systems, and more particularly, to measurement reporting in wireless communication systems. Some features may enable and provide improved communications, including transmission of power limit indications for a UE associated with different frequency bands.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes detecting, by a UE, a first trigger condition for transmission of at least a first indication of a first transmission power limit of the UE and a second indication of a second transmission power limit of the UE, wherein the first transmission power limit is associated with a first frequency band supported by the UE and the second transmission power limit is associated with a second frequency band supported by the UE and transmitting, by the UE to a first network node associated with the first frequency band, the first indication and the second indication in accordance with detection of the first trigger condition.

In an additional aspect of the disclosure, an apparatus, such as a UE, includes at least one processor and at least one memory coupled to the at least one processor. The at least one memory stores processor-readable code, and the at least one processor is configured to execute the processor-readable code to cause the at least one processor to perform operations including detecting a first trigger condition for transmission of at least a first indication of a first transmission power limit of the UE and a second indication of a second transmission power limit of the UE, wherein the first transmission power limit is associated with a first frequency band supported by the UE and the second transmission power limit is associated with a second frequency band supported by the UE and transmitting, to a first network node associated with the first frequency band, the first indication and the second indication in accordance with detection of the first trigger condition.

In an additional aspect of the disclosure, an apparatus includes means for detecting a first trigger condition for transmission of at least a first indication of a first transmission power limit of a UE and a second indication of a second transmission power limit of the UE, wherein the first transmission power limit is associated with a first frequency band supported by the UE and the second transmission power limit is associated with a second frequency band supported by the UE and means for transmitting, to a first network node associated with the first frequency band, the first indication and the second indication in accordance with detection of the first trigger condition.

In an additional aspect of the disclosure, a non-transitory computer-readable medium stores instructions that, when executed by a processor, cause the processor to perform operations. The operations include detecting a first trigger condition for transmission of at least a first indication of a first transmission power limit of a UE and a second indication of a second transmission power limit of the UE, wherein the first transmission power limit is associated with a first frequency band supported by the UE and the second transmission power limit is associated with a second frequency band supported by the UE and transmitting, to a first network node associated with the first frequency band, the first indication and the second indication in accordance with detection of the first trigger condition.

In another aspect of the disclosure, a method for wireless communication includes receiving, by a first network node from a user equipment (UE), a first indication of a first transmission power limit of the UE and a second indication of a second transmission power limit of the UE, wherein the first transmission power limit is associated with the first network node and a first frequency band supported by the UE and the second transmission power limit is associated with a second network node and a second frequency band supported by the UE and determining, by the first network node whether to initiate a handover of the UE from the first network node to the second network node based on the received first indication and second indication.

In an additional aspect of the disclosure, an apparatus, such as a first network node, includes at least one processor and at least one memory coupled to the at least one processor. The at least one memory stores processor-readable code, and the at least one processor is configured to execute the processor-readable code to cause the at least one processor to perform operations including receiving, from a user equipment (UE), a first indication of a first transmission power limit of the UE and a second indication of a second transmission power limit of the UE, wherein the first transmission power limit is associated with the first network node and a first frequency band supported by the UE and the second transmission power limit is associated with a second network node and a second frequency band supported by the UE and determining whether to initiate a handover of the UE from the first network node to the second network node based on the received first indication and second indication.

In an additional aspect of the disclosure, an apparatus includes means for receiving, from a user equipment (UE), a first indication of a first transmission power limit of the UE and a second indication of a second transmission power limit of the UE, wherein the first transmission power limit is associated with a first network node and a first frequency band supported by the UE and the second transmission power limit is associated with a second network node and a second frequency band supported by the UE and a means for determining whether to initiate a handover of the UE from the first network node to the second network node based on the received first indication and second indication.

In an additional aspect of the disclosure, a non-transitory computer-readable medium stores instructions that, when executed by a processor, cause the processor to perform operations. The operations include receiving, from a user equipment (UE), a first indication of a first transmission power limit of the UE and a second indication of a second transmission power limit of the UE, wherein the first transmission power limit is associated with a first network node and a first frequency band supported by the UE and the second transmission power limit is associated with a second network node and a second frequency band supported by the UE and determining whether to initiate a handover of the UE from the first network node to the second network node based on the received first indication and second indication.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports transmission of power limit indications for a UE associated with different frequency bands according to one or more aspects.

FIG. 4 is a block diagram of an example handover of a UE from a first base station to a second base station based on transmission of indications of power limits for the UE associated with different frequency bands to a serving base station according to one or more aspects.

FIG. 5 is graph illustrating an example UE transmission power reporting state according to one or more aspects.

FIG. 6 is a flow diagram illustrating an example process that supports transmission of power limit indications for a UE associated with different frequency bands according to one or more aspects according to one or more aspects.

FIG. 7 is a flow diagram illustrating an example process that supports transmission of power limit indications for a UE associated with different frequency bands according to one or more aspects.

FIG. 8 is a block diagram of an example UE that supports transmission of power limit indications for a UE associated with different frequency bands according to one or more aspects.

FIG. 9 is a block diagram of an example base station that supports transmission of power limit indications for a UE associated with different frequency bands according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support transmission of power limit indications for a UE associated with different frequency bands. For example, a UE may be configured with different transmission power limits associated with different frequency bands, and the different frequency bands may be associated with different base stations. Such power limits may be set based on specific absorption rate (SAR) regulatory requirements associated with different frequency bands supported by the UE, different thermal mitigation parameters associated with different frequency bands supported by the UE, different maximum power settings established in a design of the UE, and other characteristics of the UE and/or environment of the UE. A UE may, upon detection of a trigger condition, such as a transmission power of the UE exceeding a predetermined level for a predetermined period of time, transmit, to a first base station, indications of power limits associated with different frequency bands supported by the UE. Such frequency bands may, for example, include a first frequency band associated with the first base station and a second frequency band associated with a second base station. The base station may, based on the indications of the power limits, determine whether to perform a handover to transfer the UE to the second base station associated with the second frequency band. Thus, a UE may, upon detection of a trigger condition, report power limits associated with different frequency bands to a base station, and the base station may determine whether to perform a handover of the UE to another base station based on the indications of the power limits.

Particular implementations of the subject matter described in this disclosure may be implemented to realize one or more of the following potential advantages or benefits. In some aspects, the present disclosure provides techniques for enhancing radio resource utilization efficiency. For example, based on transmission power limit indications transmitted by a UE, a first base station associated with a first frequency band may hand over the UE to a second base station associated with a frequency band for which the UE has a greater transmission power limit, allowing the UE to use a greater transmission power in communicating with the base station. Such power limit-based handover may be particularly useful in scenarios where a UE transmission power on different frequency bands may be limited based on a position of one or more antennas of a UE with respect to a body of a user, as transmission power limits may vary based on SAR requirements and positioning of the UE. Furthermore, such reporting may provide a better user experience with respect to throughput and uplink quality, as a UE may be handed over to a base station associated with a frequency band having a greater power limit when a trigger condition occurs, such as when a UE has been transmitting at a power level above a threshold for a predetermined period of time.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology.

Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHZ, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

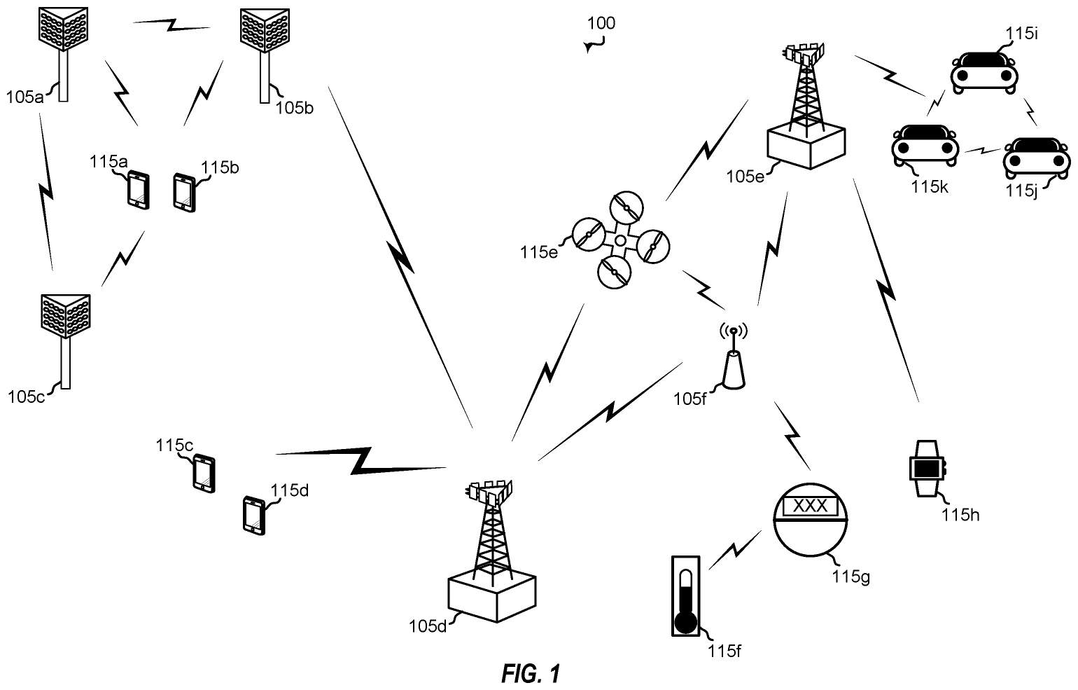

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

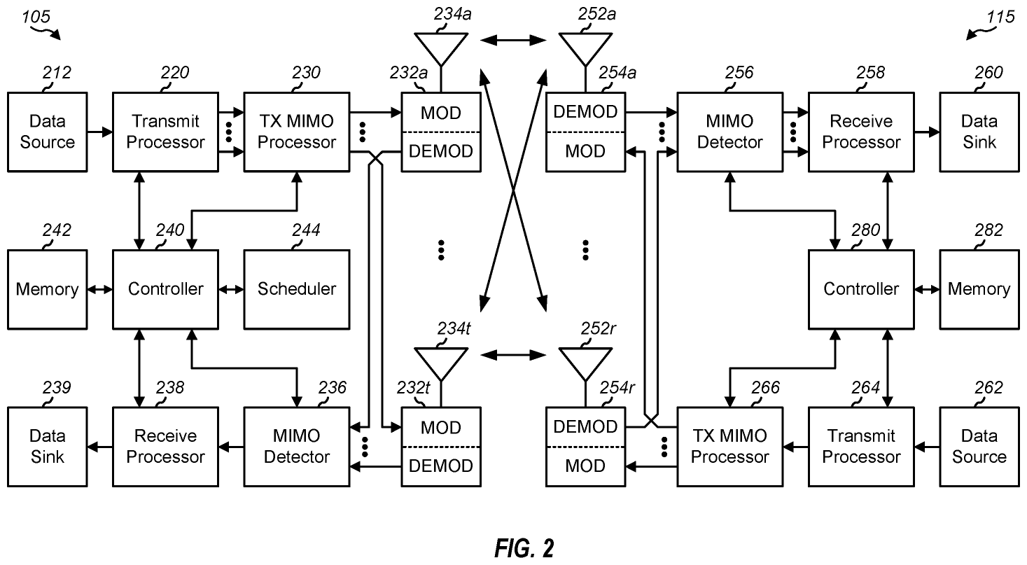

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

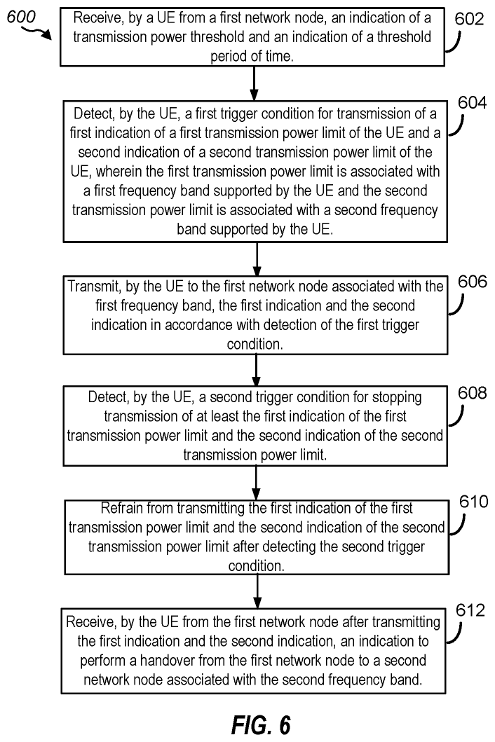

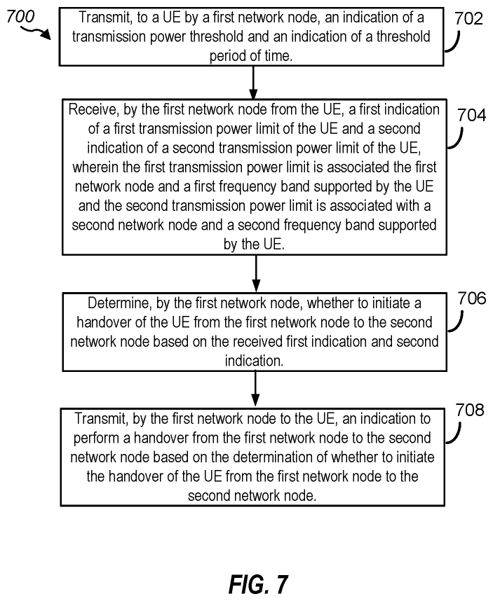

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 6-7, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

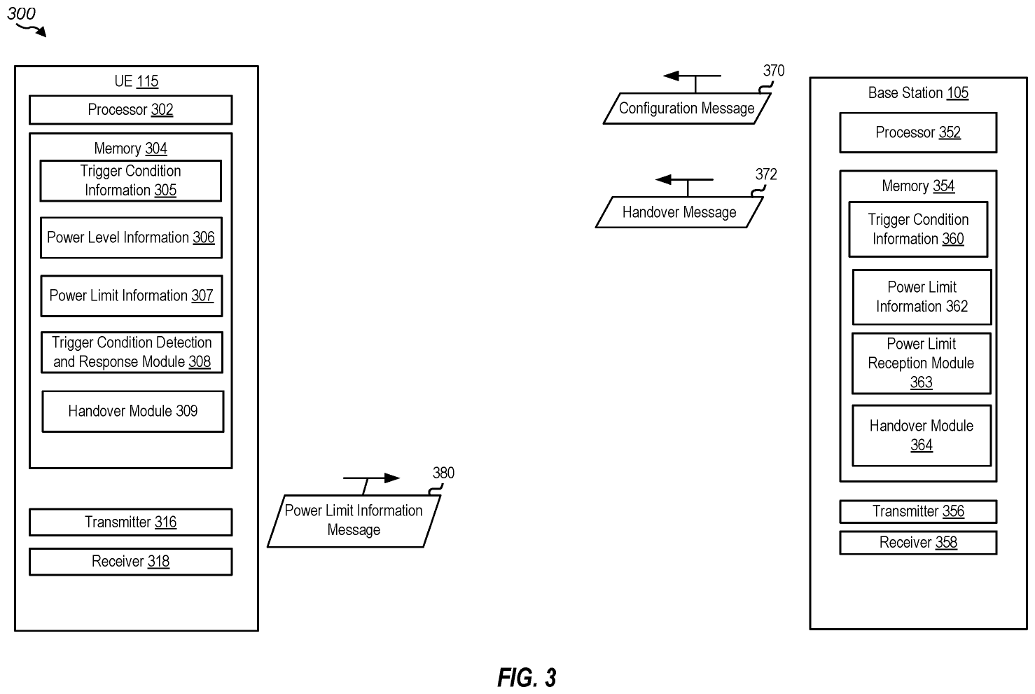

FIG. 3 is a block diagram of an example wireless communications system 300 that supports transmission of power limit indications for a UE associated with different frequency bands according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store trigger condition information 305, power level information 306, power limit information 307, a trigger condition detection and response module 308, and a handover module 309. Trigger condition information 305 may, for example, include information regarding trigger conditions of trigger events for triggering transmission of power limit information for the UE 115 to the base station 105. Trigger condition information 305 may, for example, include information regarding conditions for transmitting one or more measurement reports to the base station 105. Such conditions may, for example, be event A1, event A2, event A3, event A4, event A5, event A6, event B1, event B2, event I1, event C1, or event C2 trigger conditions identified by the 5G NR standard, or other trigger conditions, such as an event P1 trigger condition or trigger conditions of legacy technologies, such as LTE-A. Trigger condition information 305 may, for example, include requirements that must be satisfied for detection of a trigger condition. As one particular example, trigger condition information may include a threshold period of time and a transmission power threshold for a first frequency band that must be exceeded for the threshold period of time for transmission of power limit information, such as for transmission of power limit information in a measurement report. In some embodiments, the trigger condition information may include one or more offsets, such as one or more offsets from one or more power limits for setting a transmission power threshold for detecting a trigger condition. Power level information 306 may, for example, include information regarding one or more current or prior transmission power levels of the UE 115, such as a current power level at which the UE 115 is transmitting to the base station 105 on a first frequency band.

Power limit information 307 may include one or more transmission power limits for the UE 115 associated with one or more respective frequency bands supported by the UE 115. Such power limits may vary based on a position of the UE 115, a temperature of the UE 115, maximum power settings integrated in the design of the UE 115, or other environmental or internal characteristics of the UE 115. As one particular example, SAR regulations may specify a maximum power the UE may use for transmissions from particular antennas of the UE associated with particular frequency bands based on positions of the particular antennas with respect to a body of a user. Thus, when a position of the UE 115 is adjusted with respect to a body of a user, and such adjustment includes adjustment of a position of an antenna of the UE 115 with respect to a body of a user, the UE 115 may adjust a transmission power limit of a frequency band associated with the antenna based on the adjustment. Thus, the power limit information 307 may include different transmission power limits associated with different frequency bands supported by the UE 115 and/or associated antennas.

Trigger condition detection and response module 308 may include logic for detecting trigger conditions based on trigger condition information 305 and for transmitting power limit information to the base station 105 in response to detection of such conditions. Handover module 309 may include logic for performing a handover of the UE 115 from the base station 105 to another base station upon receipt of a handover message from the base station 105.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store trigger condition information 360, power limit information 362, a power limit reception module 363, and a handover module 364. The trigger condition information 360 may, for example, include trigger condition information similar to the trigger condition information 305 of the UE 115. In some embodiments, the base station 105 may configure the UE for response to various trigger conditions based on the trigger condition information 360. For example, the trigger condition information 360 may include one or more time thresholds, one or more power level thresholds, and/or one or more power offsets for configuring the UE for detection of trigger conditions as described herein. Power limit information 362 may include power limit information received from the UE 115, such as power limit information received from the UE 115 in response to detection of a trigger condition. Such power limit information 362 may include multiple respective power limits associated with multiple respective frequency bands supported by the UE 115. For example, a first transmission power limit of the power limit information 362 may be associated with a first frequency band used for communication between the UE 115 and the base station 105, and a second transmission power limit of the power limit information 362 may be associated with a second frequency band supported by the UE 115 and associated with a different base station. Power limit reception module 363 may include logic for reception of power limit information from the UE 115. Handover module 364 may include logic for determining whether to perform a handover based on received power limit information and for performing such a handover.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP. In some implementations, wireless communications system 300 implements a network different from a 5G NR network.

During operation of wireless communications system 300, base station 105 may transmit a configuration message 370 to the UE 115. The configuration message 370 may include trigger condition information 360, such as information for configuration of one or more trigger conditions for transmission of power limit information by the UE 115. As one example, the configuration message 370 may include a power threshold, such as a particular power level threshold or an offset from a power limit, for setting a particular power level threshold for triggering transmission of power limit information by the UE 115. The configuration message 370 may further include one or more timing thresholds for the UE 115. In some embodiments, the timing thresholds may, for example, include a timing threshold after which the UE 115 will detect a trigger condition and a timing threshold after which the UE 115 will detect an end of the trigger condition. The UE 115 may receive the configuration message 370.

The UE 115 may detect a trigger condition for transmission of power limit information 307 to the base station 105. For example, the UE 115 may detect that a transmission power level of the UE 115 on a first frequency band has exceeded a threshold power level, such as a threshold power level indicated by the configuration message 370, either directly or through indication of an offset from a power limit of the UE 115, for a threshold period of time, such as a threshold period of time indicated by the configuration message 370. The UE 115 may then transmit a power limit information message 380 to the base station 105. In some embodiments, power limit information messages may be transmitted to the base station 105 at regular intervals until a determination is made that the UE 115 has exited the trigger condition, such as by detecting that a transmission power level of the UE has fallen below the threshold power level for a threshold period of time. The power limit information message 380 may include power limit information 307 associated with the UE 115. For example, the power limit information message 380 may include a first power limit associated with a first frequency band and a first antenna of the UE 115 and a second power limit associated with a second frequency band and a second antenna of the UE 115. In some embodiments, the first frequency band may, for example, be a frequency band the UE 115 is using to communicate with the base station 105, such as for transmission of the power limit information message 380.

The base station 105 may receive the power limit information message 380. The base station 105 may determine whether to perform a handover of the UE 115 to another base station based on the power limit information of the power limit information message 380 and/or other factors. For example, the base station may determine that the UE 115 may be able to communicate with another base station using the second frequency band at a greater power level and may initiate a handover of the UE to the other base station based on such a determination. If the base station 105 determines to initiate a handover, the base station 105 may transmit a handover message 372 to the UE 115 to instruct the UE 115 to engage in the handover. The base station 105 may also transmit a handover message 372 to the other base station to instruct the other base station to perform the handover. The UE 115 may receive the handover message 372 and may begin communication with the other base station using the other frequency band.

As described with reference to FIG. 3, the present disclosure provides techniques for enhanced radio resource utilization efficiency by allowing a base station to initiate a handover of a UE based on changing power limits associated with different frequency bands supported by the UE 115. Furthermore, handover of a UE to a base station for communication using a frequency band for which the UE is configured with a greater transmission power limit may enhance a user experience through enhanced reliability, reduced call drops, and enhanced throughput due to an increased transmission power limit of the UE 115.

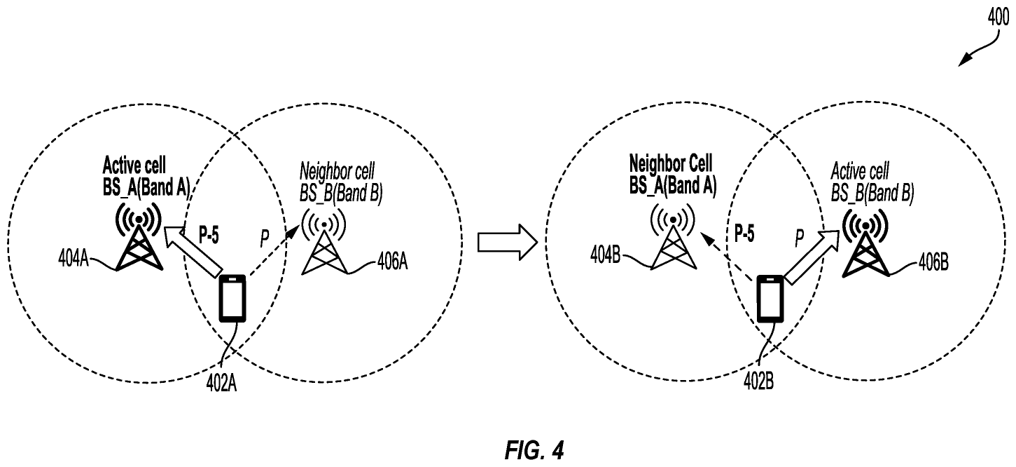

FIG. 4 is a block diagram 400 of an example handover of a UE from a first base station to a second base station based on transmission of indications of power limits for the UE associated with different frequency bands to a serving base station according to one or more aspects. At a first time, the UE 402A may communicate with a first base station 404A. The UE 402A may, for example, use a first antenna to communicate via a first frequency band with the base station 404A. The UE 402A may also be within range of a second base station 406A that supports communication using a second frequency band associated with a second antenna of the UE 402A. In some embodiments, the UE 402A may use a same antenna to communicate with both base stations 404A, 406A using the different frequency bands. In some embodiments, the base stations 404A, 406A and frequency bands may be associated with different radio access technologies (RATs). For example, the first base station 404A and frequency band may be associated with 5G NR communications, while the second base station 406A and frequency band may be associated with LTE or Wi-Fi communications. The UE 402A may be configured with different power limits for the different frequency bands, such as with different power limits for the different antennas used to communicate via the different frequency bands. Such power limits may vary over time. For example, power limits for the first frequency band associated with the first antenna and the first base station 404A and the second frequency band associated with the second antenna and the second base station 406B may be influenced by SAR regulations, thermal mitigation concerns, maximum power settings configured in design of the UE 402A, and/or other factors that may impact transmission power limits of the UE. As one particular example, SAR regulations may require the UE 402A to be configured to apply different power limits to different frequency bands associated with different antennas of the UE 402A based on positioning of the antennas of the UE 402A with respect to a body of a user. Thus, the first power limit for the first frequency band associated with the first antenna and the first base station 404A may be different from the second power limit for the second frequency band associated with the second antenna and the second base station 406A because positioning of the antennas may be different with respect to a body of a user. Furthermore, SAR regulations may require configuration for different power limits based on the particular frequency bands. Over time, such power limits may be further adjusted as a position of the UE 402A, and thus positions of the first and second antennas, with respect to a body of a user may be adjusted. Likewise, different power limits may be applied to different frequency bands based on thermal mitigation concerns and other UE configuration or design parameters.

At the first time, a first transmission power limit for the first frequency band that the UE is using to communicate with the first base station 404A may be lower than a second transmission power limit for the second frequency band supported by the UE that the UE could use for communication with the second base station 406A. In some embodiments, the first and second frequency bands may be first and second frequency bands that are both supported by a carrier. The UE 402A may report the first transmission power limit and the second transmission power limit to the first base station 404A. Such reporting may, for example, be performed based on detection of a trigger condition as discussed herein. In some embodiments, the transmission power limits may be transmitted in a measurement report or another over the air (OTA) message. The first base station may then determine whether to perform a handover of the UE 402A to the second base station 406A. For example, the first base station 404A may determine that the second base station 406A, which may be a neighbor base station, would provide the UE with better performance than the first base station 404A, based on the received first and second transmission power limits. As one example, the first base station 404A may determine that the first and second frequency bands associated with the first and second base stations 404A, 406A provide similar RX power levels but that uplink communication of the UE 402A with the second base station 406A via the second frequency band would provide greater TX power headroom. As one particular example, the first base station 505A may determine that a transmission power limit for the first frequency band is five decibels lower than a transmission power limit for the second frequency band. Based on such a determination the first base station 404A may initiate a handover of the UE 402A to the second base station 406A.

At a second time, the handover may be complete and the UE 402B, which may be the UE 402A at a second time, may communicate with the second base station 406B, which may be the second base station 406A at a second time, via the second frequency band. If transmission power limits of the UE 402B subsequently change such that the first transmission power limit for the first frequency band becomes greater than the second transmission power limit for the second frequency band and a trigger condition is satisfied for reporting of such transmission power limits to the second base station 406B, the second base station 406B may determine whether to perform a handover of the UE 402B to the first base station 404B.

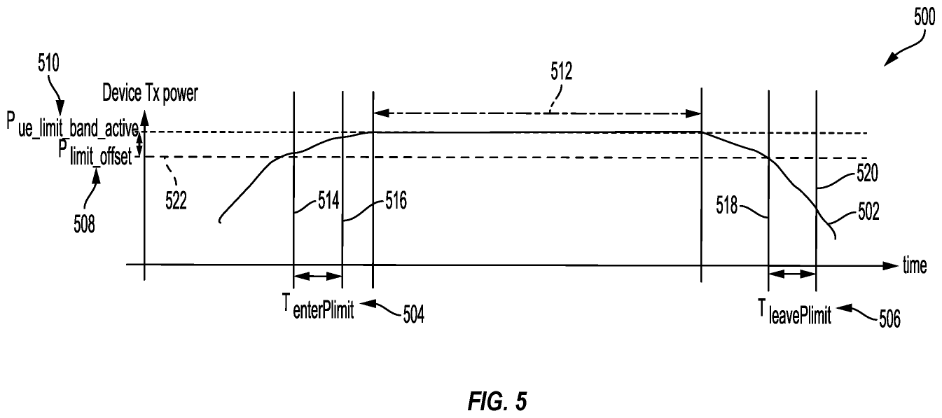

In some embodiments, a trigger condition for transmission, to a base station, of transmission power limit information for multiple frequency bands supported by a UE may be detected when the UE determines that a transmit power of the UE has exceeded a threshold power level for a predetermined period of time. FIG. 5 is a graph 500 of example transmission power 502 of a UE according to one or more aspects. A trigger condition for transmission of power limits by a UE may be detected when the transmission power 502 of the UE exceeds a threshold power level 522 for a threshold period of time 504. The threshold period of time 504 may, for example, be a T_{enterPlimit} time. The threshold period of time 504 may be configured by the base station. In some embodiments, the threshold power level 522 may be indicated directly by the base station. In some embodiments, an offset 508, such as a P_{limit_offset} from a transmission power limit may be used to determine the threshold power level 522. For example, in some embodiments, a base station may configure the offset 508 for the UE, such as by indication of the offset 508 to the UE, and the UE may subtract the offset 508 from a current transmission power limit 510, such as a P_{ue_limit_band,active} for the frequency band on which the UE is communicating with the base station to determine the threshold power level 522. In some embodiments, the offset 508 may be an absolute value, such as a value in decibels, while in other embodiments the offset 508 may be a percentage of the power limit for the frequency band on which transmission is being performed or another offset value. The UE may detect when the transmission power level 502 on the first band exceeds the threshold and initiate a timer or counter set to the threshold time 504. If the threshold time 504 expires without the power level 502 dropping below the threshold power level 522, the UE may detect the trigger condition and may transmit multiple transmission power limits associated with multiple frequency bands to the base station. In some embodiments, the multiple transmission power limits may include the transmission power limit 510 for the frequency band on which transmission is being performed. The transmission power 502 may reach the power limit 510 and may be capped at the transmission power limit 510 for time 512. In some embodiments, while the trigger condition is detected, such as after expiration of the threshold time 504 and until the power level 502 drops below the threshold power level 522 for a period of time 506, the UE may transmit transmission power limit information to the base station periodically. For example, at time 518, the UE may detect that the power level 502 has dropped below the threshold power level 522 and may initiate a timer set to threshold time 506. Threshold time 506 may be a T_{leavePlimit} threshold time and may be configured by the base station. In some embodiments, threshold time 506 may be equal to or different from threshold time 504. If the threshold time 506 elapses and the power level 502 does not rise above the threshold power level 522, the UE may detect that the trigger condition has terminated and may cease transmission of transmit power limit information to the base station. Thus, in one example trigger condition, a UE may detect a trigger condition for transmission of power limit information when a power level 502 of current transmissions exceeds a threshold power level for a threshold period of time.

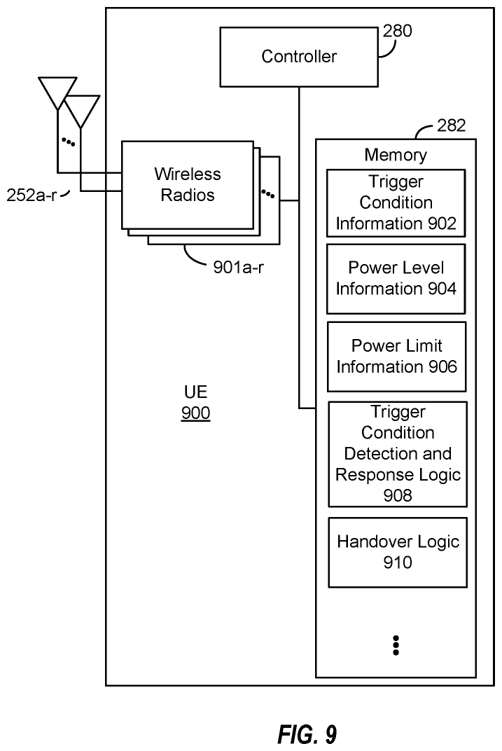

FIG. 6 is a flow diagram illustrating an example process 600 that supports transmission of power limit indications for a UE associated with different frequency bands according to one or more aspects. Operations of process 600 may be performed by a UE, such as UE 115 described above with reference to FIGS. 1, 2, 3, or a UE described with reference to FIG. 9. For example, example operations (also referred to as “blocks”) of process 600 may enable UE 115 to support transmission of power limit indications for a UE associated with different frequency bands.

In block 602, the UE may receive from a first network node, such as a first base station, an indication of a transmission power threshold and an indication of a threshold period of time. The indication of the transmission power threshold and the indication of the threshold period of time may, for example, be indications for configuring a trigger condition for a trigger event for transmission of indications of transmission power limits to the first network node. The indication of the transmission power threshold may, for example, be an indication of an offset from a transmission power limit on a first frequency band. For example, the indication of the offset may be an indication of an absolute value that should be subtracted from a transmission power limit to determine the transmission power threshold, a percentage of the transmission power limit that should be taken to determine the transmission power threshold, or another value for determining the transmission power threshold. The indication of the threshold period of time may, for example, be an indication of a time period for which a transmission power level must exceed the transmission power threshold for detection of the trigger condition. In some embodiments, multiple indications of multiple threshold periods of time may be received, such as an indication of a threshold period of time for which a transmission power level must exceed the transmission power threshold for entering the trigger condition and an indication of a different or same threshold period of time for which a transmission power level must fall below the transmission power threshold for exiting the trigger condition. In some embodiments, the UE may receive multiple sets of associated transmission power thresholds and threshold periods of time, with each set being associated with a particular frequency band supported by the UE. In some embodiments, the operations of block 602 may not be performed by a UE. For example, a UE may use a preconfigured transmission power threshold and threshold period of time for detecting a trigger condition or may otherwise detect a trigger condition for transmission of indications of transmission power limits to a first network node.

In block 604, the UE may detect a first trigger condition for transmission of a first indication of a first transmission power limit of the UE and a second indication of a second transmission power limit of the UE. For example, detecting the trigger condition may include determining that a transmission power of the UE on the first frequency band has exceeded the transmission power threshold for the threshold period of time. The transmission power threshold may, for example, be less than or equal to the first transmission power limit. The first transmission power limit may be associated with a first frequency band supported by the UE and the second transmission power limit may be associated with a second frequency band supported by the UE. In some embodiments, the first frequency band may be a first frequency band associated with a first antenna of the UE for transmission and reception on the first frequency band, and the second frequency band may be associated with a second antenna of the UE for transmission and reception on the second frequency band. In some embodiments, the UE may determine the first transmission power limit associated with the first frequency band and the second transmission power limit associated with the second frequency band. For example, the UE may determine the first transmission power limit based on a SAR associated with the first frequency band and the second transmission power limit based on a SAR associated with the second frequency band. As another example, the respective transmission power limits may be determined based on respective thermal requirements associated with the respective frequency bands, such as one or more thermal mitigation parameters associated with the respective frequency bands, respective power limit criteria established for the respective frequency bands in design of the UE, such as respective maximum transmission power settings for the respective frequency bands set based on hardware capabilities in UE design, maximum power reduction (MPR) backoff settings associated with the respective frequency bands, additional MPR (AMPR) backoff settings associated with the respective frequency bands, other respective characteristics of the UE or the environment of the UE, and/or other factors, that may impact respective transmission power limits. In some embodiments, the trigger condition may be a trigger condition associated with a different trigger event, such as a trigger condition for a trigger event identified by the 3GPP 5G NR standard. Thus, first and second indications of first and second transmission power limits associated with first and second frequency bands may be included in measurement reports transmitted in response to existing trigger events.

In block 606, the UE may transmit, to the first network node, the first indication and the second indication in accordance with detection of the trigger condition. For example, when the trigger conditions is detected, the UE may transmit the first indication of the first transmission power limit associated with the first frequency band and the second indication of the second transmission power limit associated with the second frequency band. The first network node may be associated with the first frequency band. For example, the first indication and the second indication may be transmitted, by the first UE, to the first network node on the first frequency band. In some embodiments, the first indication and the second indication may be transmitted in a first measurement report. The first and second indications may, for example, be transmitted as Plimit information of a measresults information element of the measurement report. As one particular example, the Plimit information may be transmitted in a P_ue_limit_band item of a measurement report. For example, the indication of the first transmission power limit may be a P_ue_limit_band, active value and may be a lowest value of a Ppowerclass, active, a P-max, active, a Psarbackoff, active, or a Pthermal_mitigation,active value. The active identifier may indicate that the parameter is a parameter associated with an active frequency band. Similarly, the indication of the second transmission power limit may be a P_ue_limit_band,neighbor value and may be a lowest value of a Ppowerclass, neighbor, a P-max,neighbor, a Psarbackoff,neighbor, or a Pthermal_mitigation,neighbor value. The neighbor identifier may indicate that the parameter is a parameter associated with a frequency band of a neighboring network node. A Ppowerclass parameter may, for example, be a maximum transmission power defined at a UE side for the corresponding frequency band and/or associated antenna. A Psarbackoff parameter may, for example, be a maximum transmission power defined at a UE side for the corresponding frequency band and/or associated antenna taking into account any SAR limitations on the power limit. The Pthermal_mitigation parameter may, for example, be a maximum transmission power defined at a UE side for the corresponding frequency band and/or associated antenna taking into account a thermal mitigation policy of the UE side associated with the frequency band and/or associated antenna. A Pmax parameter may, for example, be a maximum transmit power allowed by the serving cell, such as by the network node associated with the frequency band with which the Pmax parameter is associated. The measurement report may be a measurement report as identified by the 3GPP 5G NR standard. In some embodiments, the first and second indications of the first and second transmission power limits may be transmitted in the measurement report along with power headroom information. In some embodiments, the measurement report may include other receive-side metrics. In some embodiments, the first and second indications of the first and second transmission power limits may be transmitted in other over the air (OTA) transmissions or MAC control element transmissions. In some embodiments, additional indications of transmission power limits associated with additional frequency bands, network nodes, and/or antennas may be transmitted. Thus, the trigger condition may be a trigger condition for transmission of more than two respective power limit indications for more than two respective frequency bands, and the UE may transmit indications of more than two respective power limit indications for more than two respective frequency bands.

In block 608, the UE may detect a second trigger condition for stopping transmission of at least the first indication of the first transmission power limit and the second indication of the second transmission power limit. For example, transmitting the first and second indications, at block 606, may include periodic transmission of the first and second indications after detection of the first trigger condition until the second trigger condition is detected. Detection of the second trigger condition may, for example, include determining that a transmission power of the UE on the first frequency band has dropped below a threshold power level for a threshold period of time. In some embodiments, the threshold level and threshold period of time for the second trigger condition may be the same as the threshold level and threshold period of time for detection of the first trigger condition or may be different.

In block 610, the UE may refrain from transmitting the first indication of the first transmission power limit and the second indication of the second transmission power limit after detecting the second trigger condition. For example, if the UE is periodically transmitting the first and second indications after detection of the first trigger condition, the UE may, upon detection of the second trigger condition, cease such periodic transmission. Thus, in some embodiments, a UE may refrain from and/or cease transmission of indications of power limits upon detection of a second trigger condition.

In block 612, the UE may receive, from the first network node after transmitting the first indication and the second indication, an indication to perform a handover from the first network node to a second network node associated with the second frequency band. For example, the first network node may determine based on the first indication of the first transmission power limit and the second indication of the second transmission power limit to perform a handover of the UE to the second network node. As one particular example, the second transmission power limit may be greater than the first transmission power limit, and the first network node may determine that network resource utilization efficiency may be enhanced through handover of the UE from the first network node to the second network node for communication with the second network node using the second frequency band. The UE may, based on receipt of the indication to perform the handover, engage in a handover to the second network node. Following the handover, the UE may communicate with the second network node using the second frequency band.

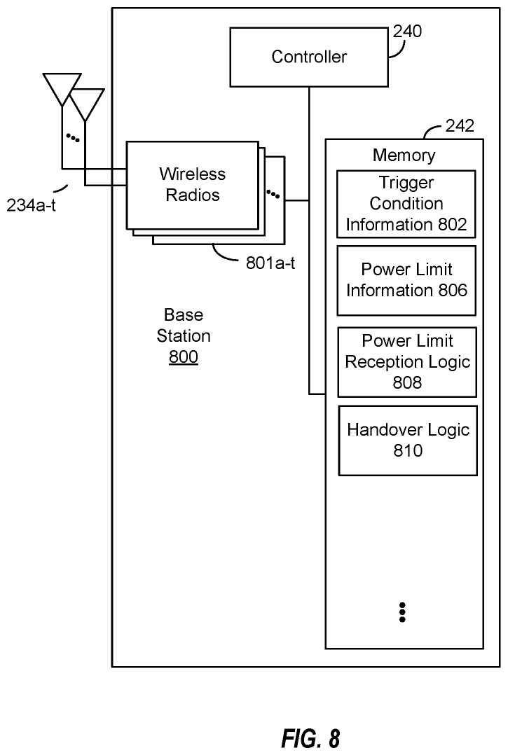

FIG. 7 is a flow diagram illustrating an example process 700 that supports transmission of power limit indications for a UE associated with different frequency bands according to one or more aspects. Operations of process 700 may be performed by a first network node, such as base station 105 described above with reference to FIGS. 1-3 or a base station as described herein with reference to FIG. 8. For example, example operations of process 700 may enable base station 105 to support transmission of power limit indications for a UE associated with different frequency bands.

At block 702, the first network node, which may be a base station, may transmit, to a UE an indication of a transmission power threshold and an indication of a threshold period of time. The power threshold and the threshold period of time may, for example, be the power threshold and threshold period of time described with respect to block 602 of FIG. 6.

At block 704, the first network node may receive, from the UE, a first indication of a first transmission power limit of the UE and a second indication of a second transmission power limit of the UE. The first transmission power limit may be associated with the first network node and a first frequency band supported by the UE, such as a first frequency band used for communication between the first network node and the UE, and the second transmission power limit may be associated with a second network node and a second frequency band supported by the UE. The first and second indications of the first and second transmission power limits may, for example, be first and second indications of first and second transmission power limits transmitted by the UE in accordance with detection of a trigger condition of a trigger event, as described with respect to blocks 604-606 of FIG. 6. The first indication and the second indication may be received in a measurement report, as described herein.

At block 706, the first network node may determine whether to initiate a handover of the UE from the first network node to the second network node based on the received first indication and second indication. Such a determination may, for example, be based on whether the first indication of the first transmission power limit is less than or equal to the second indication of the second transmission power limit. For example, when the network node determines that the UE would be able to transmit with a greater power limit if the UE were served by the second network node, the first network node may initiate the handover. The first network node may initiate the handover based on other factors as well, such as receive-side performance metrics. For example, the determination of whether to perform the handover may be further based on a reference signal received power (RSRP), a reference signal received quality (RSRQ), a downlink carrier to interference ratio (EC/IO), and other receive-side performance metrics for communication on the first frequency band between the first network node and the UE and/or on the second frequency band between the second network node and the UE.

At block 708, the first network node may transmit, to the UE, an indication to perform a handover from the first network node to the second network node based on the determination of whether to initiate the handover of the UE from the first network node to the second network node. For example, the first network node may determine to initiate a handover of the UE from the first network node to the second network node based on a determination that the second transmission power limit is greater than the first transmission power limit and may transmit an indication to perform the handover to the UE.

FIG. 8 is a block diagram of an example base station 800 that supports transmission of power limit indications for a UE associated with different frequency bands according to one or more aspects. Base station 800 may be configured to perform operations, including the blocks of process 700 described with reference to FIG. 7. In some implementations, base station 800 includes the structure, hardware, and components shown and described with reference to base station 105 of FIGS. 1-3. For example, base station 800 may include controller 240, which operates to execute logic or computer instructions stored in memory 242, as well as controlling the components of base station 800 that provide the features and functionality of base station 800. Base station 800, under control of controller 240, transmits and receives signals via wireless radios 801a-t and antennas 834a-t. Wireless radios 801a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include trigger condition information 802, power limit information 806, power limit reception logic 808, and handover logic 810. Trigger condition information 802 may include information similar to trigger condition information 360 described with respect to FIG. 3. Power limit information 806 may include information similar to power limit information 362 described with respect to FIG. 3. Power limit reception logic 808 may be configured to facilitate reception of power limit information such as indications of first and second transmission power limits as described with respect to block 704 of FIG. 7. Handover logic 810 may be configured to determine whether to perform a handover and to initiate a handover, such as described with respect to blocks 706-708 of FIG. 7. Base station 800 may receive signals from or transmit signals to one or more UEs, such as UE 115 of FIGS. 1-3 or UE 900 of FIG. 9.

FIG. 9 is a block diagram of an example UE 900 that supports transmission of power limit indications for a UE associated with different frequency bands to one or more aspects. UE 900 may be configured to perform operations, including the blocks of a process described with reference to FIG. 6. In some implementations, UE 900 includes the structure, hardware, and components shown and described with reference to UE 115 of FIGS. 1-3. For example, UE 900 includes controller 280, which operates to execute logic or computer instructions stored in memory 282, as well as controlling the components of UE 900 that provide the features and functionality of UE 900. UE 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include trigger condition information 902, power level information 904, power limit information 906, trigger condition detection and response logic 908, and handover logic 910. Trigger condition information 902 may include information similar to trigger condition information 305 described with respect to FIG. 3. Power level information 904 may include information similar to power level information 306 described with respect to FIG. 3. Power limit information 906 may include information similar to power limit information 307 described with respect to FIG. 3. Trigger condition detection and response logic 908 may be configured to facilitate reception of trigger condition configuration information, detection of trigger conditions associated with trigger events, and transmission of indications of transmission power limits in response to detection of such trigger conditions as described with respect to blocks 602-610 of FIG. 6. Handover logic 910 may be configured to facilitate receipt of handover instructions and subsequent handover of the UE 900 to another network node as described with respect to block 612 of FIG. 6.

In one or more aspects, techniques for supporting transmission of power limit indications for a UE associated with different frequency bands may include additional aspects, such as any single aspect or any combination of aspects described below or in connection with one or more other processes or devices described elsewhere herein. In a first aspect, supporting transmission of power limit indications for a UE associated with different frequency bands may include an apparatus configured to perform operations including detecting a first trigger condition for transmission of at least a first indication of a first transmission power limit of a UE and a second indication of a second transmission power limit of the UE, wherein the first transmission power limit is associated with a first frequency band supported by the UE and the second transmission power limit is associated with a second frequency band supported by the UE and transmitting, to a first network node associated with the first frequency band, the first indication and the second indication in accordance with detection of the first trigger condition. Additionally, the apparatus may perform or operate according to one or more aspects as described below. In some implementations, the apparatus includes a wireless device, such as a UE. In some implementations, the apparatus may include at least one processor, and at least one memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to perform operations including receiving, from the first network node after transmitting the first indication and the second indication, an indication to perform a handover from the first network node to a second network node associated with the second frequency band.

In a third aspect, in combination with one or more of the first aspect or the second aspect, the second transmission power limit is greater than the first transmission power limit.

In a fourth aspect, in combination with one or more of the first aspect through the third aspect, the apparatus is further configured to perform operations including determining the first transmission power limit based on at least one of: a specific absorption rate (SAR), a maximum transmission power setting, one or more thermal mitigation parameters, a maximum power reduction (MPR) backoff setting, or an additional MPR (AMPR) backoff setting associated with the first frequency band and determining the second transmission power limit based on at least one of a SAR, a maximum transmission power setting, one or more thermal mitigation parameters, a maximum power reduction (MPR) backoff setting, or an additional MPR (AMPR) backoff setting associated with the second frequency band.

In a fifth aspect, in combination with one or more of the first aspect through the fourth aspect, transmitting the first indication and the second indication comprises transmitting a measurement report including the first indication and the second indication.

In a sixth aspect, in combination with one or more of the first aspect through the fifth aspect, detecting a first trigger condition for transmission of the first indication of the first transmission power limit of the UE and the second indication of the second indication of the second transmission power limit of the UE comprises determining that a transmission power of the UE on the first frequency band has exceeded a transmission power threshold for a threshold period of time.

In a seventh aspect, in combination with one or more of the first aspect through the sixth aspect, the transmission power threshold is less than or equal to the first transmission power limit.

In an eighth aspect, in combination with one or more of the first aspect through the seventh aspect, the apparatus is further configured to perform operations including receiving, from the first network node, an indication of the transmission power threshold and an indication of the threshold period of time.

In a ninth aspect, in combination with one or more of the first aspect through the eighth aspect, the first frequency band is associated with a first antenna of the UE and the second frequency band is associated with a second antenna of the UE.

In a tenth aspect, in combination with one or more of the first aspect through the ninth aspect, the apparatus is further configured to perform operations including detecting a second trigger condition for stopping transmission of at least the first indication of the first transmission power limit of the UE and the second indication of the second transmission power limit of the UE and refraining from transmitting the first indication of the first transmission power limit of the UE and the second indication of the second transmission power limit of the UE after detecting the second trigger condition.

In one or more aspects, techniques for supporting transmission of power limit indications for a UE associated with different frequency bands may include additional aspects, such as any single aspect or any combination of aspects described below or in connection with one or more other processes or devices described elsewhere herein. In an eleventh aspect, supporting transmission of power limit indications for a UE associated with different frequency bands may include an apparatus configured to perform operations including receiving, from a user equipment (UE), a first indication of a first transmission power limit of the UE and a second indication of a second transmission power limit of the UE, wherein the first transmission power limit is associated with a first network node and a first frequency band supported by the UE and the second transmission power limit is associated with a second network node and a second frequency band supported by the UE and determining whether to initiate a handover of the UE from the first network node to the second network node based on the received first indication and second indication. Additionally, the apparatus may perform or operate according to one or more aspects as described below. In some implementations, the apparatus includes a wireless device, such as a base station. In some implementations, the apparatus may include at least one processor, and at least one memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twelfth aspect, in combination with the eleventh aspect, the apparatus is further configured to perform operations including transmitting, to the UE, an indication to perform a handover from the first network node to the second network node based on the determination of whether to initiate the handover of the UE from the first network node to the second network node.

In a thirteenth aspect, in combination with one or more of the eleventh aspect through the twelfth aspect, the second transmission power limit is greater than the first transmission power limit.

In a fourteenth aspect, in combination with one or more of the eleventh aspect through the thirteenth aspect, receiving the first indication and the second indication comprises receiving a measurement report including the first indication and the second indication.

In a fifteenth aspect, in combination with one or more of the eleventh aspect through the fourteenth aspect, the apparatus is further configured to perform operations including transmitting, to the UE, an indication of a transmission power threshold associated with the first transmission power limit and an indication of a threshold period of time associated with the first transmission power limit.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 and 8-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium.

Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A user equipment (UE), comprising:
at least one memory storing processor-readable code; and
at least one processor coupled to the at least one memory, the at least one processor configured to execute the processor-readable code to cause the at least one processor to perform operations including:
detecting a first trigger condition for transmission of at least a first indication of a first transmission power limit of the UE and a second indication of a second transmission power limit of the UE, wherein the first transmission power limit is associated with a first frequency band supported by the UE and the second transmission power limit is associated with a second frequency band supported by the UE; and
transmitting, to a first network node associated with the first frequency band, the first indication and the second indication in accordance with detection of the first trigger condition.

2. The UE of claim 1, wherein the at least one processor is further configured to execute the processor-readable code to cause the at least one processor to perform operations including:
receiving, from the first network node after transmitting the first indication and the second indication, an indication to perform a handover from the first network node to a second network node associated with the second frequency band.

3. The UE of claim 2, wherein the second transmission power limit is greater than the first transmission power limit.

4. The UE of claim 1, wherein the at least one processor is further configured to execute the processor-readable code to cause the at least one processor to perform operations including:
determining the first transmission power limit based on at least one of: a specific absorption rate (SAR), a maximum transmission power setting, one or more thermal mitigation parameters, a maximum power reduction (MPR) backoff setting, or an additional MPR (AMPR) backoff setting associated with the first frequency band; and
determining the second transmission power limit based on at least one of a SAR, a maximum transmission power setting, one or more thermal mitigation parameters, a maximum power reduction (MPR) backoff setting, or an additional MPR (AMPR) backoff setting associated with the second frequency band.

5. The UE of claim 1, wherein transmitting the first indication and the second indication comprises transmitting a measurement report including the first indication and the second indication.

6. The UE of claim 1, wherein detecting a first trigger condition for transmission of the first indication of the first transmission power limit of the UE and the second indication of the second indication of the second transmission power limit of the UE comprises:
determining that a transmission power of the UE on the first frequency band has exceeded a transmission power threshold for a threshold period of time.

7. The UE of claim 6, wherein the transmission power threshold is less than or equal to the first transmission power limit.

8. The UE of claim 6, wherein the at least one processor is further configured to execute the processor-readable code to cause the at least one processor to perform operations including:
receiving, from the first network node, an indication of the transmission power threshold and an indication of the threshold period of time.

9. The UE of claim 1, wherein the first frequency band is associated with a first antenna of the UE and the second frequency band is associated with a second antenna of the UE.

10. The UE of claim 1, wherein the at least one processor is further configured to execute the processor-readable code to cause the at least one processor to perform operations including:
detecting a second trigger condition for stopping transmission of at least the first indication of the first transmission power limit of the UE and the second indication of the second transmission power limit of the UE; and
refraining from transmitting the first indication of the first transmission power limit of the UE and the second indication of the second transmission power limit of the UE after detecting the second trigger condition.

11. A method, comprising:
detecting, by a UE, a first trigger condition for transmission of at least a first indication of a first transmission power limit of the UE and a second indication of a second transmission power limit of the UE, wherein the first transmission power limit is associated with a first frequency band supported by the UE and the second transmission power limit is associated with a second frequency band supported by the UE; and
transmitting, by the UE to a first network node associated with the first frequency band, the first indication and the second indication in accordance with detection of the first trigger condition.

12. The method of claim 11, further comprising:
receiving, by the UE from the first network node after transmitting the first indication and the second indication, an indication to perform a handover from the first network node to a second network node associated with the second frequency band.

13. The method of claim 12, wherein the second transmission power limit is greater than the first transmission power limit.

14. The method of claim 11, further comprising:
determining, by the UE, the first transmission power limit based on at least one of: a specific absorption rate (SAR), a maximum transmission power setting, one or more thermal mitigation parameters, a maximum power reduction (MPR) backoff setting, or an additional MPR (AMPR) backoff setting associated with the first frequency band; and
determining, by the UE, the second transmission power limit based on at least one of: a SAR, a maximum transmission power setting, one or more thermal mitigation parameters, a maximum power reduction (MPR) backoff setting, or an additional MPR (AMPR) backoff setting associated with the second frequency band.

15. The method of claim 11, wherein transmitting the first indication and the second indication comprises transmitting a measurement report including the first indication and the second indication.

16. The method of claim 11, wherein detecting a first trigger condition for transmission of the first indication of the first transmission power limit of the UE and the second indication of the second indication of the second transmission power limit of the UE comprises:
determining that a transmission power of the UE on the first frequency band has exceeded a transmission power threshold for a threshold period of time.

17. The method of claim 16, wherein the transmission power threshold is less than or equal to the first transmission power limit.

18. The method of claim 16, further comprising:
receiving, by the UE from the first network node, an indication of the transmission power threshold and an indication of the threshold period of time.

19. The method of claim 11, wherein the first frequency band is associated with a first antenna of the UE and the second frequency band is associated with a second antenna of the UE.

20. The method of claim 11, further comprising:
detecting a second trigger condition for stopping transmission of at least the first indication of the first transmission power limit of the UE and the second indication of the second transmission power limit of the UE; and
refraining from transmitting the first indication of the first transmission power limit of the UE and the second indication of the second transmission power limit of the UE after detecting the second trigger condition.

21. A first network node, comprising:
at least one memory storing processor-readable code; and
at least one processor coupled to the at least one memory, the at least one processor configured to execute the processor-readable code to cause the at least one processor to perform operations including:
receiving, from a user equipment (UE), a first indication of a first transmission power limit of the UE and a second indication of a second transmission power limit of the UE, wherein the first transmission power limit is associated with the first network node and a first frequency band supported by the UE and the second transmission power limit is associated with a second network node and a second frequency band supported by the UE; and
determining whether to initiate a handover of the UE from the first network node to the second network node based on the received first indication and second indication.

22. The first network node of claim 21, wherein the at least one processor is further configured to execute the processor-readable code to cause the at least one processor to perform operations including:
transmitting, to the UE, an indication to perform a handover from the first network node to the second network node based on the determination of whether to initiate the handover of the UE from the first network node to the second network node.

23. The first network node of claim 22, wherein the second transmission power limit is greater than the first transmission power limit.

24. The first network node of claim 21, wherein receiving the first indication and the second indication comprises receiving a measurement report including the first indication and the second indication.

25. The first network node of claim 21, wherein the at least one processor is further configured to execute the processor-readable code to cause the at least one processor to perform operations including:
transmitting, to the UE, an indication of a transmission power threshold associated with the first transmission power limit and an indication of a threshold period of time associated with the first transmission power limit.

26. A method, comprising:
receiving, by a first network node from a user equipment (UE), a first indication of a first transmission power limit of the UE and a second indication of a second transmission power limit of the UE, wherein the first transmission power limit is associated with the first network node and a first frequency band supported by the UE and the second transmission power limit is associated with a second network node and a second frequency band supported by the UE; and
determining, by the first network node whether to initiate a handover of the UE from the first network node to the second network node based on the received first indication and second indication.

27. The method of claim 26, further comprising:
transmitting, by the first network node to the UE, an indication to perform a handover from the first network node to the second network node based on the determination of whether to initiate the handover of the UE from the first network node to the second network node.

28. The method of claim 27, wherein the second transmission power limit is greater than the first transmission power limit.

29. The method of claim 26, wherein receiving the first indication and the second indication comprises receiving a measurement report including the first indication and the second indication.

30. The method of claim 26, further comprising:
transmitting, to the UE, an indication of a transmission power threshold associated with the first transmission power limit and an indication of a threshold period of time associated with the first transmission power limit.
